(19) United States
(12) Patent Application Publication
(10) Pub. No.: US 2012/0206424 A1
(43) Pub. Date: Aug. 16, 2012

(54) DISPLAY DRIVING CIRCUIT AND OPERATION METHOD APPLICABLE THERETO

(75) Inventors: Ji-Ting Chen, Hsinchu County (TW); Kuang-Feng Sung, Taichung City (TW)

(73) Assignee: NOVATEK MICROELECTRONICS CORP., Hsinchu (TW)

(21) Appl. No.: 13/369,358

(22) Filed: Feb. 9, 2012

(30) Foreign Application Priority Data
Feb. 11, 2011 (TW) 100104646

(51) Int. Cl. G09G 5/00

(52) U.S. Cl. 345/204

(57) ABSTRACT

A display driving circuit includes: a circuit under test; a first circuit, selectively coupled to the circuit under test and selectively coupled to an output, the first circuit having a stabilization period longer than that of the circuit under test; and a test auxiliary circuit, coupled to the circuit under test. In normal operation, after a normal signal flows into the circuit under test, the normal signal flows into the first circuit but not into the test auxiliary circuit. In test, after a test signal flows into the circuit under test, the test signal flows into the test auxiliary circuit but not into the first circuit.

This application claims the benefit of Taiwan application Serial No. 100104646, filed Feb. 11, 2011, the subject matter of which is incorporated herein by reference.

### TECHNICAL FIELD

The disclosure relates in general to a display driving circuit and an operation method applicable thereto, and more particularly to a display driving circuit and an operation method applicable thereto, which avoid circuits which take a long convergence time to stabilization in test.

### BACKGROUND

After manufacture, circuits are further tested to verify whether its operations are normal. Let a source driving circuit be taken for example. The analog output portion thereof normally includes elements such as multi-bit digital to analog converters, operational amplifiers and so on. If the digital to analog converter is m-bit, then it needs 2^{m} tests for verifying whether all internal signal paths of the m-bit digital to analog converter are normal or not. The digital to analog converter and its source driving circuit will be rejected as long as one signal path fails in test. In conventional test, the circuit characteristics of the operational amplifier will result in a long convergence time (that is, the required time to achieve stabilization is long), hence prolonging the overall test time.

### BRIEF SUMMARY

The disclosure is directed to a display driving circuit and an operation method applicable thereto. In testing the display driving circuit, the test signal does not flow into elements which take a long convergence time to achieve stabilization, so that the test time may be shortened.

According to an exemplary example of the disclosure, a display driving circuit including a circuit under test, a first circuit, and a test auxiliary circuit is provided. The first circuit is selectively coupled to the circuit under test, and is further selectively coupled to an output terminal, wherein a stabilization period of the first circuit is longer than that of the circuit under test. The test auxiliary circuit is coupled to the circuit under test. In normal operation, after a normal signal flows into the circuit under test, the normal signal flows into the first circuit but not into the test auxiliary circuit. In test, after a test signal flows into the circuit under test, the test signal flows into the test auxiliary circuit but not into the first circuit.

According to another exemplary example of the disclosure, an operation method applicable to a display driving circuit is provided. The method includes: conducting a normal signal into a circuit under test of the display driving circuit, through a first circuit but not into a test auxiliary circuit when the display driving circuit is in normal operation; and conducting a test signal into the circuit under test, through the test auxiliary circuit but not into the first circuit when the display driving circuit is in test. The first circuit is selectively coupled to the circuit under test, and is further selectively coupled to an output terminal. A stabilization period of the first circuit is longer than that of the circuit under test.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 shows a circuit diagram of a source driving circuit according to a first embodiment of the disclosure;

FIG. 2 shows another possible implementation of the source driving circuit according to the first embodiment;

FIG. 3 shows yet another possible implementation of the source driving circuit according to the first embodiment;

FIG. 4 shows a circuit diagram of a source driving circuit and a test method applicable thereto according to a second embodiment of the disclosure;

FIG. 5 shows another test method of the source driving circuit according to the second embodiment of the disclosure;

FIG. 6 shows a configuration diagram of a digital to analog converter according to the second embodiment of the disclosure; and

FIG. 7 shows a circuit diagram of a source driving circuit according to a third embodiment of the disclosure.

### DETAILED DESCRIPTION OF EMBODIMENTS OF THE DISCLOSURE

According to the display driving circuit and the test method applicable there to disclosed in a number of embodiments of the disclosure, in test, elements, usually operational amplifiers, which take a long convergence time to achieve stabilization are avoided, so that the test time may further be shortened.

### First Embodiment

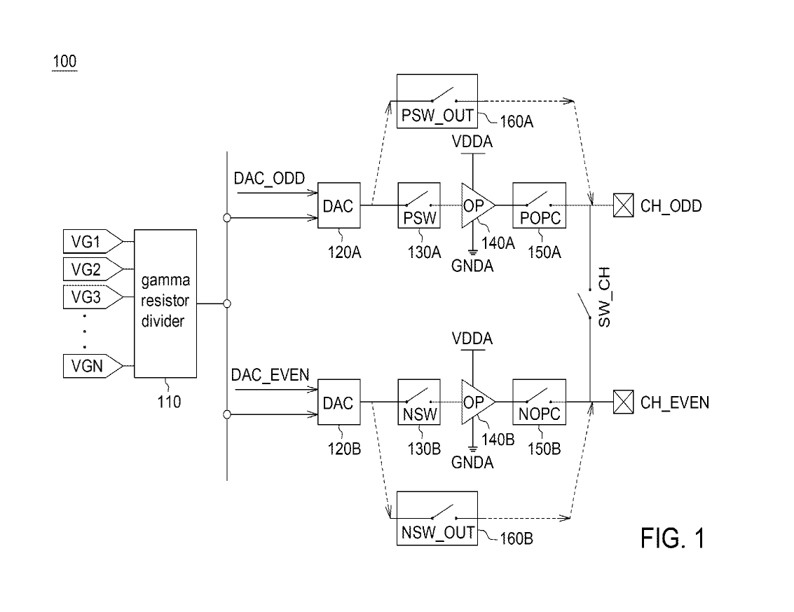

Referring to FIG. 1, a circuit diagram of a source driving circuit according to a first embodiment of the disclosure is shown. As indicated in FIG. 1, the source driving circuit 100 of the first embodiment of the disclosure at least includes a gamma resistor divider 110, digital to analog converters (DAC) 120A˜120B, switches 130A˜130B, operational amplifiers 140A˜140B, output switches 150A˜150B, test auxiliary circuits 160A˜160B and a charge sharing switch SW_CH. The structure of the gamma resistor divider 110 is not subjected to any restrictions, and the details are not repeated here.

In FIG. 1, when the source driving circuit 100 is in normal operation, data inputted to the source driving circuit 100 flows through the digital to analog converters 120A˜120B, the switches 130A˜130B, the operational amplifiers 140A˜140B and the output switches 150A˜150B, and is outputted from the output terminal CH_ODD and CH_EVEN. When the source driving circuit 100 is in normal operation, the test auxiliary circuit is in an OFF state.

In FIG. 1, the test path is denoted by dotted lines. As indicated in FIG. 1, in testing the source driving circuit, the test signal inputted into the digital to analog converter 120A˜120B flows through the test auxiliary circuits 160A˜160B and is outputted from the output terminals CH_ODD and CH_EVEN. In test, the switches 130A˜130B and 150A˜150B are in an OFF state, so that the output terminals CH_ODD and CH_EVEN will not receive the output results from the operational amplifiers and the test auxiliary circuits at the same time. In FIG. 1, the test auxiliary circuit is realized by such as a switch.

Since the test signal does not pass through the circuits that take long convergence time to achieve stabilization (such as the operational amplifiers 140A˜140B), the test time may thus be shortened.

In addition, the number of internal signal paths of the operational amplifier is not as many as that of the digital to analog converter. Thus, when testing an internal signal path of the digital to analog converter, whether the operational amplifier is in normal operation may be tested at the same time. That is, whether the operational amplifier is capable of transmitting the complete voltage to the output terminal is tested.

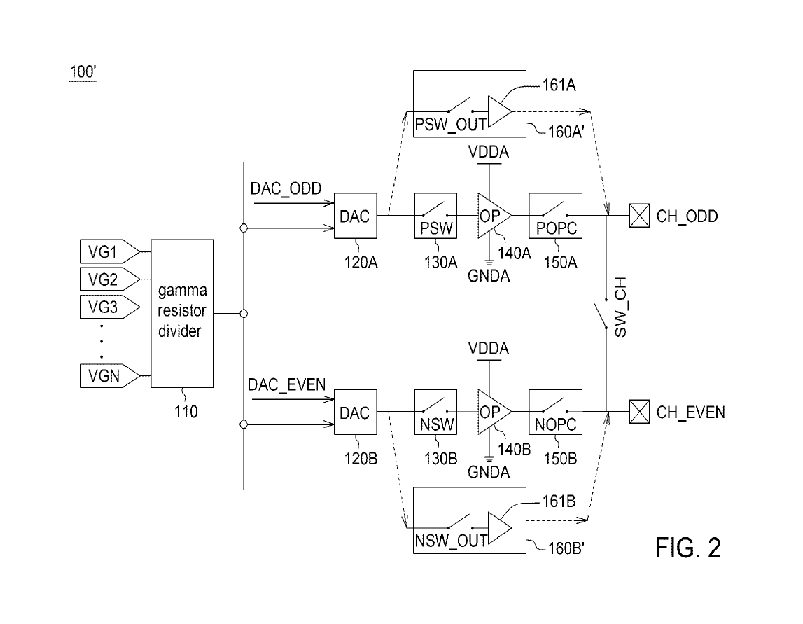

FIG. 2 shows another possible implementation of the source driving circuit of the first embodiment. As indicated in FIG. 2, in the source driving circuit 100A′, the test auxiliary circuits 160A′ and 160B′ are different from the test auxiliary circuits 160A and 160B of FIG. 1, and other elements are similar or the same.

As indicated in FIG. 2, the test auxiliary circuit 160A′ includes a switch PSW_OUT and a buffer circuit 161A. Similarly, the test auxiliary circuit 160B′ includes a switch NSW_OUT and a buffer circuit 161B. The buffer circuits 161A and 161B are such as fast stable, and the configuration thereof is simpler than that of the operational amplifiers 140A and 140B. For example, the buffer circuits 161A and 161B have fewer transistors with low driving capacity. However, the buffer circuits 161A and 161B still have a little driving ability and are capable of lifting some of the loading effect on the output terminal.

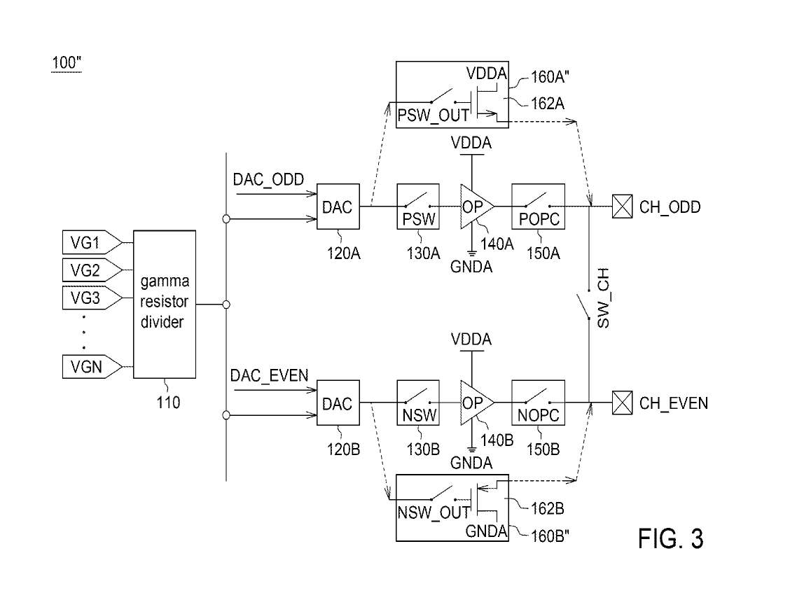

FIG. 3 shows yet another possible implementation of the source driving circuit of the first embodiment. As indicated in FIG. 3, in the source driving circuit 100A″, the test auxiliary circuits 160A″ and 160B″ are different from the test auxiliary circuits 160A and 160B of FIG. 1, and other elements are similar or the same.

As indicated in FIG. 3, the test auxiliary circuit 160A″ includes a switch PSW_OUT and a level shifter 162A capable of enhancing the current for driving the loading at next stages. Similarly, the test auxiliary circuit 160B″ includes a switch NSW_OUT and a level shifter 162B.

### Second Embodiment

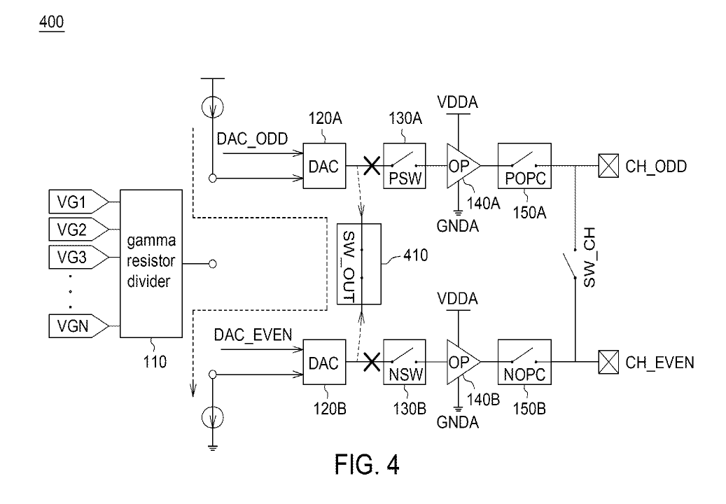

FIG. 4 shows a circuit diagram of a source driving circuit and a test method applicable thereto according to a second embodiment of the disclosure. As indicated in FIG. 4, the source driving circuit 400 of the second embodiment of the disclosure at least includes a gamma resistor divider 110, digital to analog converters 120A˜120B, switches 130A˜130B, operational amplifiers 140A˜140B, output switches 150A˜150B, a switch 410 and a charge sharing switch SW_CH. The elements identical or similar to the previous embodiment are not repeated here.

In FIG. 4, when the source driving circuit 100 is in normal operation, input data flows through the digital to analog converters 120A˜120B, the switches 130A˜130B, the operational amplifiers 140A˜140B and the output switches 150A˜150B and is outputted from the output terminals CH_ODD and CH_EVEN. When the source driving circuit 100 is in normal operation, the switch 410 is in an OFF state.

In FIG. 4, the test path is denoted by dotted lines. As indicated in FIG. 4, when testing the source driving circuit, the test current is inputted into one of the digital to analog converters 120A˜120B and outputted to the other digital to analog converter from the switch 410. In test, the switches 130A˜130B and 150A˜150B are all in an OFF state to avoid the amplifier from draining the test current and thus affecting the accuracy of test result. In test, the gamma resistor divider 110 is not coupled to the digital to analog converters 120A˜120B.

Since the test signal does not pass the circuits that take a long convergence time to stabilize (such as the operational amplifiers 140A˜140B), the test time may thus be shortened.

If the digital to analog converters 120A˜120B are in normal operation, the test current inputted into one of the digital to analog converters 120A˜120B should be equal to the current measured at the other of the digital to analog converters 120A˜120B. If the values of the currents are not the same, this implies that at least one of the digital to analog converters fails. Moreover, the configuration of FIG. 4 may test two digital to analog converters at a time. However, which digital to analog converter fails is not to be identified because the source driving circuit will be rejected as long as one of the digital to analog converters fails.

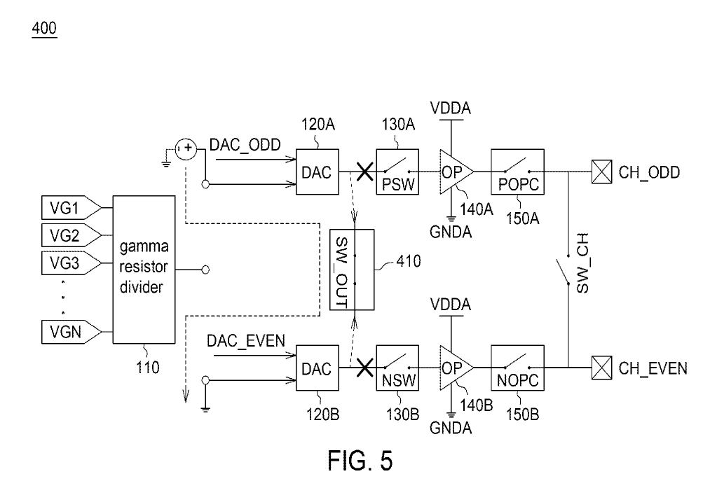

FIG. 5 shows another test method for testing the source driving circuit 400 according to the second embodiment of the disclosure. In FIG. 5, the signal paths denoted by dotted lines are the paths for testing. As indicated in FIG. 5, when testing the source driving circuit, the test voltage is inputted into one of the digital to analog converters and outputted from the other digital to analog converter via the switch 410. In test, the switches 130A˜130B and 150A˜150B are all in an OFF state to avoid the amplifier from draining the voltage under test and thus affecting the accuracy of test result. Besides, in test, the gamma resistor divider 110 is not coupled to the digital to analog converters 120A˜120B.

Since the test signal does not pass through the circuit that take a long convergence time to stabilize (such as the operational amplifiers 140A˜140B), the test time may thus be shortened.

In test, the internal test paths of the digital to analog converter are determined by the tester. The test voltage is known. If the digital to analog converters 120A˜120B are both in normal operation, then the voltage measured at the other digital to analog converter should be equal to an ideal value, otherwise, this implies that at least one digital to analog converter fails. The configuration of FIG. 5 may test two digital to analog converters at a time. However, which digital to analog converter fails is not to be identified because the source driving circuit will be rejected as long as one digital to analog converter fails.

The comparison between the first and the second embodiments of the disclosure shows that the switch 410 of the second embodiment may be regarded as another implementation of the test auxiliary circuit of the first embodiment. In the first embodiment, the test auxiliary circuit is coupled between the circuit under test (such as the digital to analog converter) and the output terminal, so that the test signal is prevented from flowing through the circuits that take a long convergence time to stabilize (such as the operational amplifier). To the contrary, in the second embodiment, the test auxiliary circuit is coupled between two circuits under test, so that the test signal is prevented from flowing through the circuits that take a long convergence time to stabilize (such as the operational amplifier).

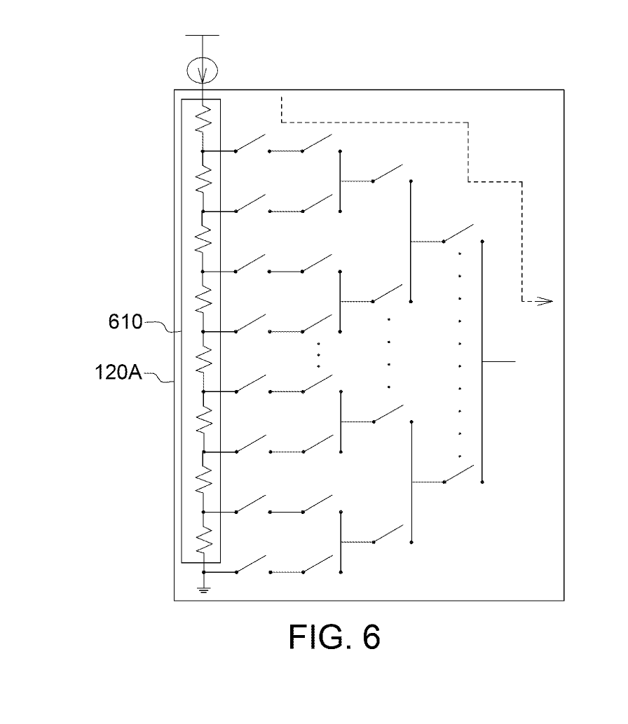

FIG. 6 a configuration diagram of the digital to analog converter according to the second embodiment of the disclosure. As indicated in FIG. 6, the digital to analog converter 120A includes several switches (not illustrated) for selecting the reference voltage divided from the resistor string 610. In the second embodiment of the disclosure, in test, the internal signal paths of the digital to analog converters may be bi-directional. That is, the internal signal paths of the digital to analog converters may direct to the output terminal from the input terminal, or direct from the output terminal to the input terminal.

### Third Embodiment

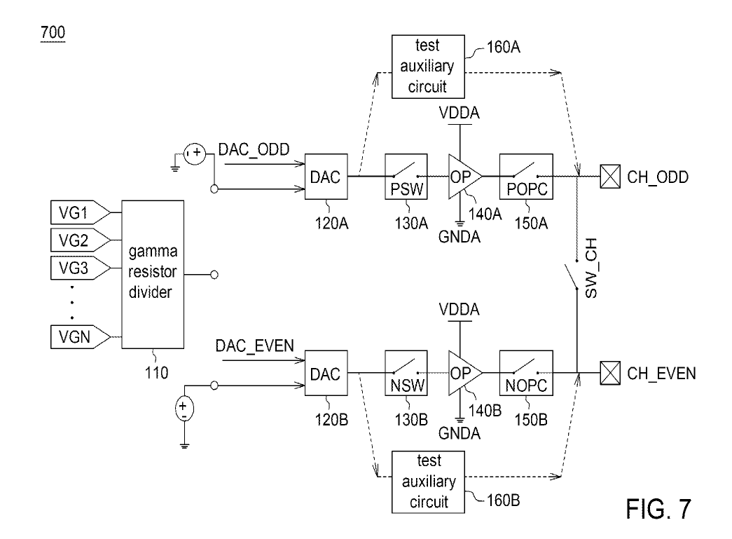

FIG. 7 shows a circuit diagram of a source driving circuit according to a third embodiment of the disclosure. As indicated in FIG. 7, the source driving circuit 700 of the third embodiment of the disclosure at least includes a gamma resistor divider 110, digital to analog converters 120A˜120B, switches 130A˜130B, operational amplifiers 140A˜140B, output switches 150A˜150B, test auxiliary circuits 160A˜160B and a charge sharing switch SW_CH.

As indicated in FIG. 7, the third embodiment of the disclosure may be regarded as a combination of the first and the second embodiments. That is, in test, the test voltage (or the test current) is inputted into the digital to analog converters 120A˜120B, flows through the test auxiliary circuits 160A˜160B and is outputted from the output terminals CH_ODD and CH_EVEN. Whether the operation of the digital to analog converter is normal may be determined by verifying the output voltage (or the output current) at the output terminals CH_ODD and CH_EVEN.

The test auxiliary circuits 160A˜160B may be implemented as illustrated in the first and the second embodiments.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. A display driving circuit, comprising:
a circuit under test;
a first circuit selectively coupled to the circuit under test and further selectively coupled to an output terminal, wherein a stabilization period of the first circuit is longer than that of the circuit under test; and
a test auxiliary circuit coupled to the circuit under test;
wherein,
in normal operation, after a normal signal flows into the circuit under test, the normal signal flows into the first circuit but not into the test auxiliary circuit; and
in test, after a test signal flows into the circuit under test, the test signal flows into the test auxiliary circuit but not into the first circuit.

2. The display driving circuit according to claim 1, wherein, the circuit under test comprises a digital to analog converter, and the first circuit comprises an operational amplifier.

3. The display driving circuit according to claim 1, further comprising:
a first switch coupled between the circuit under test and the first circuit; and
a second switch coupled between the first circuit and the output terminal;
wherein,
in normal operation, the first and the second switches are both ON for conducting the normal signal to flow into the first and the second switches; and
in test, the first and the second switches are both OFF.

4. The display driving circuit according to claim 1, wherein, the test auxiliary circuit comprises:
a test auxiliary switch coupled between the circuit under test and the output terminal;
wherein,
in normal operation, the test auxiliary switch is OFF; and
in test, the test auxiliary switch is ON for conducting the test signal to flow into the test auxiliary switch.

5. The display driving circuit according to claim 1, wherein, the test auxiliary circuit comprises:
a test auxiliary switch coupled to the circuit under test; and
a driving unit coupled between the test auxiliary switch and the output terminal;
wherein,
in normal operation, the test auxiliary switch and the driving unit are both OFF; and
in test, the test auxiliary switch and the driving unit are both ON for conducting the test signal to flow into the test auxiliary switch and the driving unit.

6. The display driving circuit according to claim 1, further comprising another circuit under test, and the test auxiliary circuit is coupled between the circuit under test and the other circuit under test;
wherein,
in normal operation, the normal signal flows into the circuit under test and the other circuit under test but not into the test auxiliary circuit; and
in test, the test signal into the circuit under test flows through the test auxiliary circuit so as to reach the other circuit under test.

7. The display driving circuit according to claim 6, wherein, the test signal comprises a test current or a test voltage.

8. An operation method applicable to a display driving circuit, comprising:
conducting a normal signal into a circuit under test of the display driving circuit, through a first circuit but not into a test auxiliary circuit when the display driving circuit is in normal operation; and
conducting a test signal into the circuit under test, through the test auxiliary circuit but not into the first circuit when the display driving circuit is in test;
wherein,
the first circuit is selectively coupled to the circuit under test and is further selectively coupled to an output terminal; and
a stabilization period of the first circuit is longer than that of the circuit under test.

9. The operation method according to claim 8, wherein, the circuit under test comprises a digital to analog converter, and the first circuit comprises an operational amplifier.

10. The operation method according to claim 8, wherein, the display driving circuit further comprises a first switch coupled between the circuit under test and the first circuit, and a second switch coupled between the first circuit and the output terminal;
the operation method further comprises:
in normal operation, controlling the first and the second switches ON for conducting the normal signal to flow into the first and the second switch; and
in test, controlling the first and the second switches OFF.

11. The operation method according to claim 8, wherein, the test auxiliary circuit of the display driving circuit comprises a test auxiliary switch coupled between the circuit under test and the output terminal;
the operation method further comprises:
in normal operation, controlling the test auxiliary switch OFF; and
in test, controlling the test auxiliary switch ON for conducting the test signal to flow into the test auxiliary switch.

12. The operation method according to claim 8, wherein, the test auxiliary circuit of the display driving circuit comprises a test auxiliary switch coupled to the circuit under test, and a driving unit coupled between the test auxiliary switch and the output terminal;
the operation method further comprises:
in normal operation, controlling the test auxiliary switch and the driving unit OFF; and
in test, controlling the test auxiliary switch and the driving unit ON for conducting the test signal to flow into the test auxiliary switch and the driving unit.

13. The operation method according to claim 8, wherein, the display driving circuit further comprises another circuit under test, and the test auxiliary circuit is coupled between the circuit under test and the other circuit under test;
the operation method further comprises:
in normal operation, controlling the normal signal to flow into the circuit under test and the other circuit under test but not into the test auxiliary circuit; and
in test, controlling the test signal into the circuit under test to flow through the test auxiliary circuit so as to reach the other circuit under test.

14. The operation method according to claim 13, wherein, the test signal comprises a test current or a test voltage.
